(19) United States
(12) Patent Application Publication
(10) Pub. No.: US 2025/0317843 A1
(43) Pub. Date: Oct. 9, 2025

(54) ELECTRONIC DEVICE, METHOD OF CONTROLLING ELECTRONIC DEVICE, AND STORAGE MEDIUM STORING PROGRAM

(71) Applicant: CANON KABUSHIKI KAISHA, Tokyo (JP)

(72) Inventor: Shinichi Ichimura, Kanagawa (JP)

(21) Appl. No.: 19/097,004

(22) Filed: Apr. 1, 2025

(30) Foreign Application Priority Data
Apr. 4, 2024 (JP) 2024-060967

(51) Int. Cl. H04W 48/20; H04L 41/0803

(52) U.S. Cl. CPC H04W 48/20; H04L 41/0803

(57) ABSTRACT

An electronic device receives a request to change a connection destination access point; changes, based on the received change request, the connection destination access point from a first access point to a second access point; confirms, based on the connection destination access point being changed based on the change request, whether communication between the electronic device and a communication device via the second access point is possible; changes, based on confirmation that communication between the electronic device and the communication device via the second access point is not possible, the connection destination access point from the second access point to the first access point.

### BACKGROUND OF THE INVENTION

### Field of the Invention

The present invention relates to an electronic device capable of changing a connection destination access point, a method of controlling the electronic device, and a storage medium storing a program.

### Description of the Related Art

There is a technique for dynamically switching a connection destination AP so as to exchange data efficiently between an AP and a station (STA) in an extended service set (ESS) constituted by a plurality of access points (AP). Upon determining that a connection destination AP is to be switched based on congestion of the AP to which the STA is connected and vacancy, signal conditions, and the like of other APs, the connected AP transmits a connection destination AP change request to the STA. When the connection destination AP change request is received, the STA switches the connection destination AP according to the request and can thereby connect to an appropriate AP.

Japanese Patent Laid-Open No. 2021-175068 discloses the following as processing for a router having the functions of an AP to request a connected wireless station to change the connection destination. A mobile router (MR1) that can connect with a plurality of wireless stations confirms whether the wireless station terminals support IEEE 802.11v. Whether a wireless station terminal supports IEEE 802.11v can be determined from an Association Request frame, which is transmitted when the wireless station terminal wirelessly connects to MR1. If a wireless station terminal supports IEEE 802.11v, a BSS Transition Management (BTM) Request frame is transmitted to that wireless station terminal. In a BSS Transition Candidate List Entries field of the BTM Request frame, the BSSID of a master router RT2 is designated as the connection destination. A wireless station terminal is thus prompted to switch the connection destination, and the wireless station terminal switches the connection destination from MR1 to RT2 according to the received BTM Request frame.

### SUMMARY OF THE INVENTION

The present invention provides an electronic device that reduces occurrence of failures in communication with an external apparatus due to a change of a connection destination access point, a method of controlling the electronic device, and a storage medium storing a program.

The present invention in one aspect provides an electronic device comprising: at least one memory and at least one processor configured to cause the electronic device to function as: a reception unit configured to receive a request to change a connection destination access point; a first change unit configured to change, based on the change request received by the reception unit, the connection destination access point from a first access point to a second access point; a first confirmation unit configured to confirm, based on the connection destination access point being changed based on the change request, whether communication between the electronic device and a communication device via the second access point is possible; a second change unit configured to change, based on the first confirmation unit confirming that communication between the electronic device and the communication device via the second access point is not possible, the connection destination access point from the second access point to the first access point.

According to the present invention, it is possible to reduce occurrence of failures of communication with an external device due to a change of a connection destination access point.

Further features of the present invention will become apparent from the following description of exemplary embodiments with reference to the attached drawings.

### BRIEF DESCRIPTION OF THE DRAWINGS

FIG. 1 is a diagram illustrating a configuration of a system.

FIGS. 2A and 2B are diagrams illustrating a configuration of an MFP.

FIGS. 3A to 3C are diagrams illustration an operation display unit of the MFP.

FIGS. 4A and 4B are diagrams illustrating a configuration of a mobile terminal device.

FIG. 5 is a diagram illustrating a configuration of an access point.

FIG. 6 is a sequence diagram for explaining processing performed in response to a connection destination change request from the AP.

FIGS. 7A and 7B are flowcharts for explaining processing to be executed in response to a connection destination AP change request.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

When an STA receives a connection destination AP change request from an AP and changes the connection destination to another, recommended AP, it is unknown whether the STA can continue communicating with another STA, with which it had been communicating via the AP before the change, even after the change. Therefore, a failure of communication with an external STA due to a change of a connection destination AP may occur.

According to the present disclosure, it is possible to reduce occurrence of failures of communication with an external device due to a change of a connection destination access point.

### First Embodiment

### Configuration of System

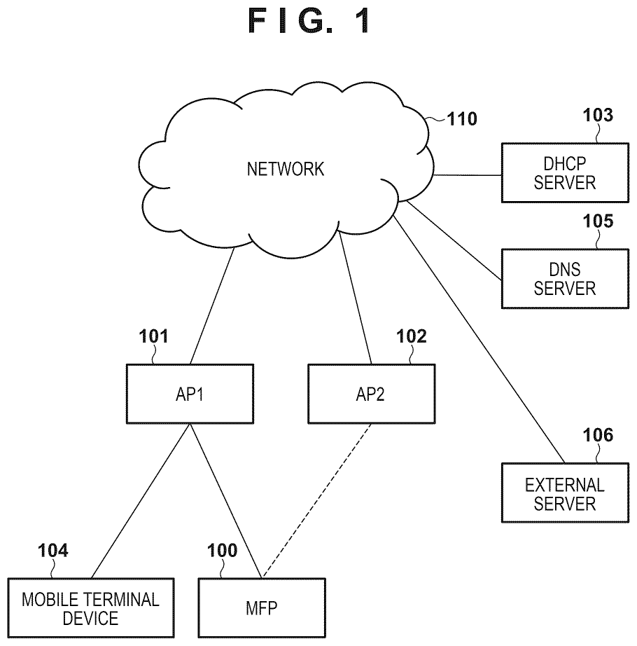

FIG. 1 illustrates an example of a configuration of a system according to the present embodiment. In one example, the system is a wireless communication system in which a plurality of communication devices can wirelessly communicate with each other. The example of FIG. 1 includes, as communication devices, a mobile terminal device 104, an MFP 100, and an AP 101 and an AP 102, which are access points, and a DHCP server 103, a DNS server 105, an external server 106, and a network 110. The AP 101 and the AP 102 may be illustrated as AP1 and AP2. The mobile terminal device 104 is a device having a function for wireless communication by a wireless LAN or the like. In the following, a wireless LAN may be referred to as a WLAN. The mobile terminal device 104 may be a personal information terminal (e.g., a personal digital assistant (PDA)), a mobile telephone (smartphone), a digital camera, a personal computer, or the like.

The MFP 100 is a printing device having a printing function and may further include a reading function (scanner), a FAX function, and a telephone function. Further, the MFP 100 of the present embodiment has a communication function that allows wireless communication with the mobile terminal device 104. Further, in the present embodiment, a case where the MFP 100 is used will be described as an example, but the present invention is not limited thereto. For example, a scanner device, a projector, a mobile terminal, a smartphone, a notebook PC, a tablet terminal, a PDA, a digital camera, a music player, a TV, a smart speaker, or the like, each having a communication function, may be used in place of the MFP 100. MFP is an acronym of Multi Function Peripheral.

The AP 101 is provided separately from (external to) the mobile terminal device 104 and the MFP 100 and operates as a WLAN base station device. A communication device having a WLAN communication function can communicate in WLAN infrastructure mode via the AP 101. In the following, an access point may be referred to as an “AP”. The infrastructure mode may be referred to as the “wireless infrastructure mode.” The AP 101 performs wireless communication with an (authenticated) communication device with which it has permitted to connect, and relays wireless communication between that communication device and another communication device. The AP 101 may, for example, be connected to a wired communication network and relay communication between a communication device connected to the wired communication network and another communication device wirelessly connected to the AP 101.

The AP 102 has the same functions as the AP 101, and the MFP 100 switches the connection from the AP 101 to the AP 102 as necessary. The DHCP server 103 connects with the MFP 100 through the network 110 and the AP 101 and, by responding to requests from the MFP 100, provides a DHCP service to the MFP 100. A configuration in which the DHCP server 103 is connected as a device separate from the AP 101 and the AP 102 in FIG. 1 has been described, but a configuration in which the AP 101 and the AP 102 have a DHCP server function may be taken. The DNS server 105 is connected with the MFP 100 and the mobile terminal device 104 through the network 110 and the AP 101 and, by responding to requests from the MFP 100 and the mobile terminal device 104, provides services for name resolution. The external server 106 connects with the MFP 100 through the network 110 and the AP 101 and, by responding to requests from the MFP 100, provides services to the MFP 100. For example, the external server 106 corresponds to a network update server that distributes firmware of the MFP 100 or a cloud printing server that communicates with the MFP 100 over the Internet and transmits print data. Here the network 110 may be the so-called Internet or may be a closed network in a company or a mobile phone network. The system according to the present embodiment is not limited to the configuration illustrated in FIG. 1 and may include, for example, an authentication server that performs the above authentication.

### External Configuration of MFP

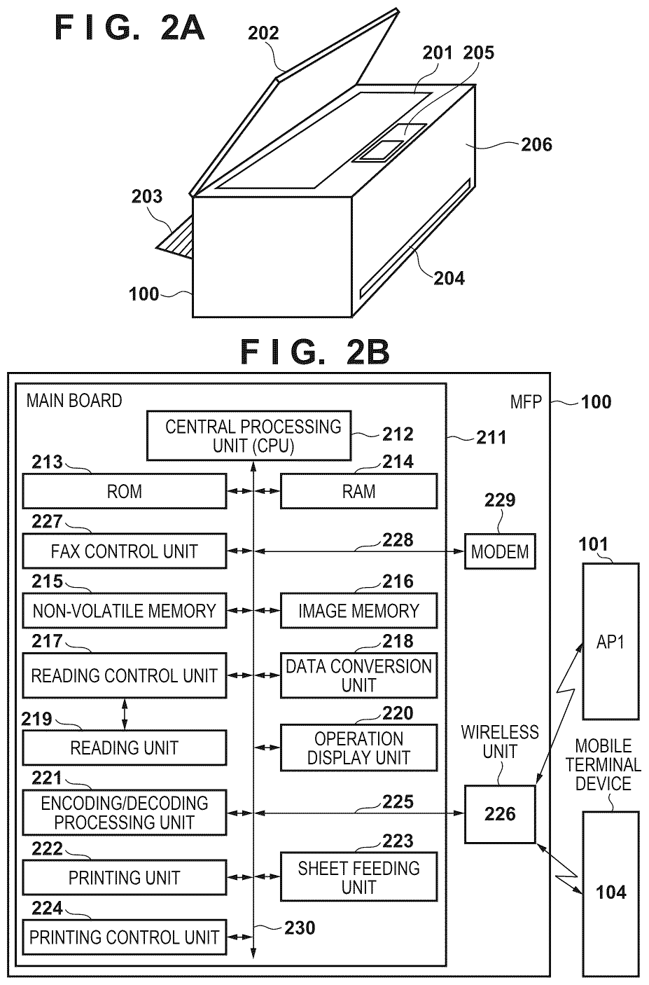

FIG. 2A illustrates an example of an external configuration of the MFP 100. The MFP 100 includes, for example, a document table 201, a document cover 202, a printing sheet insertion port 203, a printing sheet discharge port 204, and an operation display unit 205. The document table 201 is a table on which a document to be read is placed. The document cover 202 is a cover for holding a document placed on the document table 201 and for preventing light from a light source that irradiates the document from leaking out at the time of reading. The printing sheet insertion port 203 is an insertion port in which sheets of various sizes can be set. The printing sheet discharge port 204 is a discharge port for discharging a sheet on which printing has been completed. Sheets set in the printing sheet insertion port 203 are conveyed to a printing unit one at a time and, after printing has been performed thereon in the printing unit, are discharged from the printing sheet discharge port 204. The operation display unit 205 is configured to include keys (e.g., character input keys, a cursor key, an enter key, and a cancel key), an LED or LCD, and the like, and is configured to be capable of accepting activation of various functions and operations for various settings for the MFP by a user. The operation display unit 205 may be configured to include a touch panel display. The MFP 100 has a function for wireless communication by a WLAN and is configured to include, for wireless communication therefor, an antenna 206 for wireless communication although it need not necessarily be externally visible. Similarly to the mobile terminal device 104, the MFP 100 can perform wireless communication in 2.4-GHz and 5-GHz frequency bands by a WLAN.

### Configuration of MFP

FIG. 2B illustrates an example of a configuration of the MFP 100. The MFP 100 is configured to include a main board 211, which performs main control of the device itself, and a wireless unit 226, which is one of the communication modules (communication interfaces) that perform WLAN communication using at least one common antenna. The MFP 100 is configured to include a modem 229 for performing, for example, wired communication. The main board 211 is configured to include, for example, a central processing unit (CPU) 212, a ROM 213, a RAM 214, a non-volatile memory 215, an image memory 216, a read control unit 217, a data conversion unit 218, a reading unit 219, and an encoding/decoding processing unit 221. Further, the main board 211 includes, for example, a printing unit 222, a sheet feeding unit 223, a print control unit 224, and an operation display unit 220. These functional units in the main board 211 are connected to each other through a system bus 230 managed by the CPU 212. Further, the main board 211 and the wireless unit 226 are connected, for example, via a dedicated bus 225, and the main board 211 and the modem 229 are connected, for example, via a bus 228.

The CPU 212 is a system control unit including at least one processor and controls the entire MFP 100. The processes of the MFP 100 to be described below are realized, in one example, by the CPU 212 executing a program stored in the ROM 213. Dedicated hardware for each process may be provided. The ROM 213 stores control programs, an embedded OS program, and the like to be executed by the CPU 212. In the present embodiment, the CPU 212 performs software control, such as scheduling and task switching, by executing the respective control programs stored in the ROM 213 under the control of the embedded OS, which is similarly stored in the ROM 213.

The RAM 214 is constituted by an SRAM or the like. The RAM 214 stores data such as program control variables and data such as setting values registered by the user and management data of the MFP 100. The RAM 214 may be used as a buffer for various kinds of work. The non-volatile memory 215 is constituted by a memory, such as a flash memory, for example, and continues to store data even when the power of the MFP 100 is turned off. The image memory 216 is constituted by a memory such as a DRAM. The image memory 216 stores image data received through the wireless unit 226, image data processed by the encoding/decoding processing unit 221, and the like. The memory configuration of the MFP 100 is not limited to the above configuration. The data conversion unit 218, for example, performs analysis of data in various formats and converts image data to print data.

The read control unit 217 controls the reading unit 219 (e.g. a contact image sensor (CIS)) to optically read a document placed on the document table 201. The read control unit 217 converts an image obtained by optically reading the document into electrical image data (image signal) and outputs it. At this time, the read control unit 217 may output the image data after performing various kinds of image processing such as binarization processing and halftone processing.

The operation display unit 220 is the operation display unit 205 described with reference to FIG. 2A and, for example, executes display on a display based on display control by the CPU 212 and generates a signal corresponding to acceptance of a user operation. The encoding/decoding processing unit 221 performs encoding processing and decoding processing of image data (JPEG, PNG, etc.) handled by the MFP 100 and enlargement/reduction processing.

The sheet feeding unit 223 holds sheets for printing. The sheet feeding unit 223 can supply a set sheet under the control of the print control unit 224. The sheet feeding unit 223 may include a plurality of sheet feeding units so as to hold a plurality of types of sheets in a single device, and can control which sheet feeding unit to feed a sheet from under the control of the print control unit 224.

The print control unit 224 performs various kinds of image processing, such as smoothing processing, printing density correction processing, and color correction, on image data to be printed and outputs the processed image data to the printing unit 222. The printing unit 222 is configured to be capable of executing, for example, inkjet printing processing, and prints an image on a print medium, such as a sheet, by causing a print head to discharge ink supplied from an ink tank. The printing unit 222 may be configured to be capable of executing another kind of printing processing such as electrophotographic printing processing. The print control unit 224 may periodically read out information of the printing unit 222 and update, for example, status information including the remaining amount of the ink tank, the status of the print head, and the like stored in the RAM 214.

The wireless unit 226 is a unit capable of providing a WLAN communication function and can provide a function similar to a WLAN unit 429 of the mobile terminal device 104. That is, the wireless unit 226 converts data into packets and transmits the packets to another device according to a WLAN standard, and reconstructs original data from packets from another, external device and outputs it to the CPU 212. The wireless unit 226 is capable of communicating as a station conforming to the IEEE 802.11 standard series, in particular, a station conforming to IEEE 802.11a/b/g/n/ac/ax. In the following, a station may be referred to as an STA, and is capable of communicating as an STA supporting Wi-Fi Agile Multiband™.

The wireless unit 226 supports IEEE 802.11ax, that is, Wi-Fi6™, and the MFP 100 can also operate as an STA supporting at least one of Orthogonal Frequency-Division Multiple Access (OFDMA) and Target Wake Time (TWT). Since TWT is supported, a timing of data communication from a master device to an STA is adjusted. The wireless unit 226 (MFP 100), which is an STA, causes the communication function to transition to a sleep state when there is no need to stand by for signal reception. By this, power consumption can be reduced. Further, the wireless unit 226 supports Wi-Fi 6E™. That is, it can also communicate in a 6-GHz band (5.925 GHz to 7.125 GHz). Frequency bands in the 5-GHz band that are targets of Dynamic Frequency Selection (DFS) are not in the 6-GHz band. Therefore, in communication in the 6-GHz band, communication disconnection due to DFS standby time does not occur, and more pleasant communication can be expected.

The mobile terminal device 104 and the MFP 100 are capable of P2P (WLAN) communication that is based on WFD, and the wireless unit 226 has a software access point (soft AP) function or a group owner function. That is, the wireless unit 226 can construct a P2P communication network and determine the channel to be used in P2P communication.

### Operation Display Unit of MFP

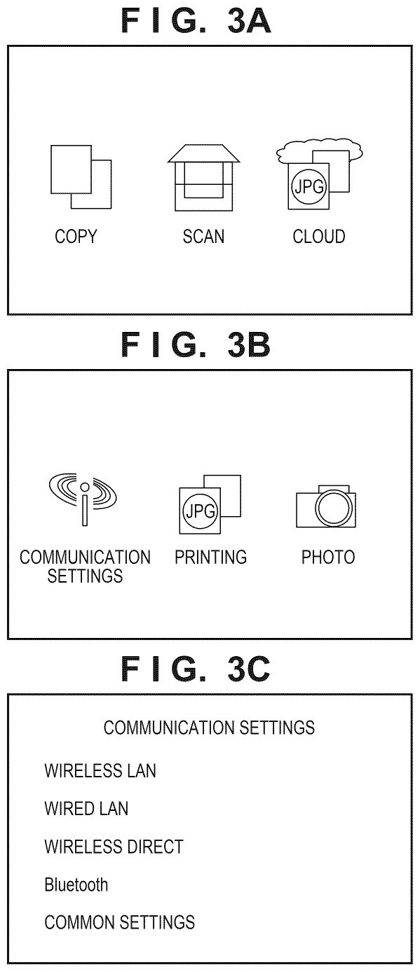

FIGS. 3A to 3C schematically illustrate examples of screen displays in a display (touch panel display) included in the operation display unit 220 of the MFP 100. FIG. 3A is an example of a home screen to be displayed when the power of the MFP 100 is turned on and while no operation, such as printing or scanning, is being performed (idle state and standby state). In FIG. 3A, display items (menu items), respectively corresponding to copy, scan, and cloud, are displayed. Cloud is a menu item related to a cloud function that uses Internet communication. The MFP 100 may start execution of a corresponding setting or function by one of the menu items being selected by a key operation or a touch panel operation. The MFP 100 can display a screen that is different from FIG. 3A in a seamless manner by receiving a key operation or a touch panel operation on the home screen in FIG. 3A.

FIG. 3B is an example of display of another part of the home screen and is a screen to which transition is made from the state of FIG. 3A by an operation (e.g., a left/right sliding operation) for displaying another page of the home screen. In FIG. 3B, display items (menu items), respectively corresponding to communication settings, print, and photo, are displayed. When one of these menu items is selected, the function, that is, a print function, a photo function, or communication settings, corresponding to the selected menu item is executed.

FIG. 3C is an example of a display of a communication setting menu screen to be displayed when communication settings is selected on the screen of FIG. 3B. “Wireless LAN”, “wired LAN”, “Wireless Direct”, “Bluetooth” and “shared settings” are displayed as menu items (options) on the communication setting menu screen. “Wireless LAN”, “wired LAN”, and “Wireless Direct” are menu items for performing LAN settings, and from these items, settings such as wired connection settings, a wireless infrastructure mode enable/disable setting, and a P2P mode (e.g., WFD and soft AP mode) enable/disable setting can be performed. If the item “wireless LAN” is selected and a wireless LAN is set to enabled by a user operation, wireless infrastructure mode will be enabled. If the item “Wireless Direct” is selected and Wireless Direct is set to enabled by a user operation, P2P (WLAN) mode will be enabled. In addition, by the item “common settings” being selected, this screen displays a shared setting menu related to each form of connection. Further, from this screen, the user can perform, for example, wireless LAN frequency band and frequency channel settings.

### External Configuration of Mobile Terminal Device

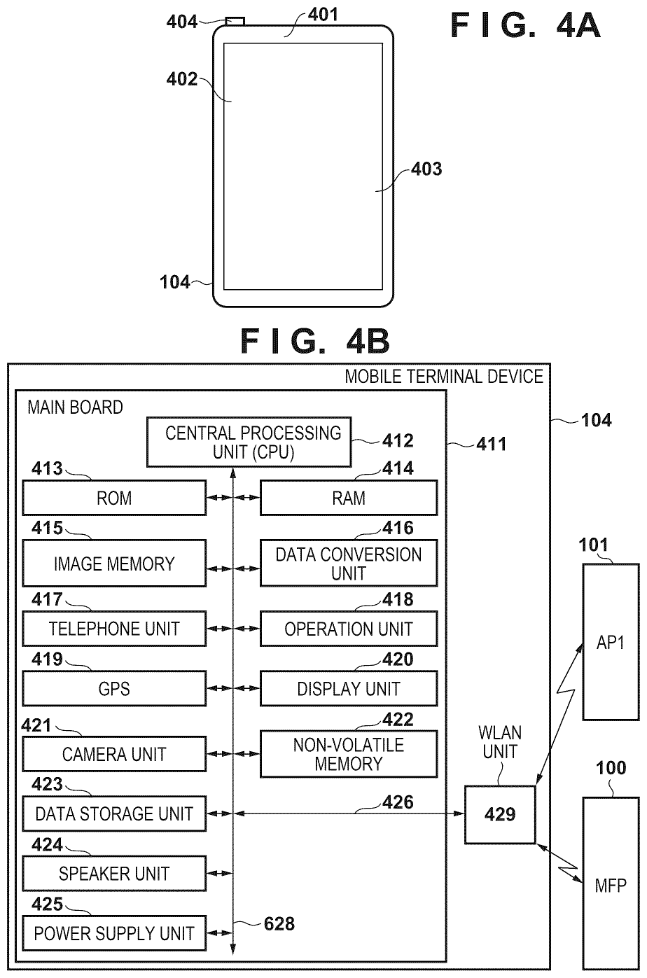

FIG. 4A is a diagram illustrating an example of an external configuration of the mobile terminal device 104. In the present embodiment, as one example, a case where the mobile terminal device 104 is a common type of smartphone will be described. The mobile terminal device 104 is configured to include, for example, a display unit 402, an operation unit 403, and a power key 404. The display unit 402 is, for example, a display that includes a liquid crystal display (LCD) mechanism. The display unit 402 may display information using, for example, light emitting diodes (LEDs) and the like. In addition to or in place of the display unit 402, the mobile terminal device 104 may have a function for outputting information by voice. The operation unit 403 is configured to include physical keys (e.g., keys and buttons), a touch panel, and the like for detecting user operations. In this example, since display of information on the display unit 402 and reception of user operations by the operation unit 403 are performed using the same touch panel display, the display unit 402 and the operation unit 403 are realized by one device. In this case, for example, button icons and a software keyboard are displayed using the display function of the display unit 402, and the user's touch on those locations is detected by the operation reception function of the operation unit 403. A configuration may be taken so as to separate the display unit 402 and the operation unit 403 and separately provide hardware for display and hardware for operation reception. The power key 404 is a physical key for receiving a user operation for turning the power of the mobile terminal device 104 on or off.

The mobile terminal device 104 includes a WLAN unit 401, which provides a WLAN communication function, although it need not necessarily be externally visible. The WLAN unit 401 is configured to be capable of executing data (packet) communication in a WLAN system conforming to, for example, the IEEE 802.11 standard series (e.g., IEEE 802.11a/b/g/n/ac/ax), and is capable of communicating as an AP supporting Wi-Fi Agile Multiband™. However, the WLAN unit 401 is not limited thereto and may be capable of performing communication in a WLAN system conforming to another standard. In this example, it is assumed that the WLAN unit 401 is capable of performing communication in both the 2.4-GHz and 5-GHz frequency bands. Further, it is assumed that the WLAN unit 401 is capable of performing communication based on WFD, communication according to the soft AP mode, communication according to the wireless infrastructure mode, and the like. Operations in these modes will be described later.

### Configuration of Mobile Terminal Device

FIG. 4B illustrates an example of a configuration of the mobile terminal device 104. The mobile terminal device 104 includes, in one example, a main board 411, which performs main control of the device itself, and the WLAN unit 429, which performs WLAN communication. The main board 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. Here, CPU is an acronym for central processing unit, ROM for read only memory, RAM for random access memory, and GPS for Global Positioning System. Further, the mobile terminal device 104 includes a display unit 420 and an operation unit 418. These functional units in the main board 411 are connected to each other through a system bus 628 managed by the CPU 412. Further, the main board 411 and the WLAN unit 429 are connected, for example, via a dedicated bus 426.

The CPU 412 is a system control unit including at least one processor and controls the entire mobile terminal device 104. The processes of the mobile terminal device 104 to be described below are realized, in one example, by the CPU 412 executing a program stored in the ROM 413. Dedicated hardware for each process may be provided. The ROM 413 stores control programs, an embedded operating system (OS) program, and the like to be executed by the CPU 412. In the present embodiment, the CPU 412 performs software control, such as scheduling and task switching, by executing the respective control programs stored in the ROM 413 under the control of the embedded OS, which is similarly stored in the ROM 413.

The RAM 414 is constituted by a static RAM (SRAM) or the like. The RAM 414 stores data such as program control variables and data such as setting values registered by the user and management data of the mobile terminal device 104. The RAM 414 may be used as a buffer for various kinds of work. The image memory 415 is constituted by a memory such as a dynamic RAM (DRAM). The image memory 415 temporarily stores image data received through the WLAN unit 429 and image data read from the data storage unit 423 for processing in the CPU 412. The non-volatile memory 422 is constituted by a memory, such as a flash memory, for example, and continues to store data even when the power of the mobile terminal device 104 is turned off. The memory configuration of the mobile terminal device 104 is not limited to the above configuration. For example, the image memory 415 and the RAM 414 may be shared, or the data storage unit 423 may be used, for example, to back up data. Further, although a DRAM has been given as an example of the image memory 415 in the present embodiment, another storage medium, such as a hard disk or a non-volatile memory, may be used.

The data conversion unit 416 analyzes various types of data and performs data conversion, such as color conversion and image conversion. The telephone unit 417 controls the telephone line and realizes communication by telephone by processing voice data inputted and outputted through the speaker unit 424. The GPS 419 receives radio waves transmitted from satellites and obtains position information of the mobile terminal device 104, such as the current latitude and longitude.

The camera unit 421 has a function for electronically recording and encoding an image inputted through a lens. Image data obtained by imaging by the camera unit 421 is stored in the data storage unit 423. The speaker unit 424 performs control for realizing a function for inputting or outputting a voice for the telephone function and a function for alarm notification and the like. The power supply unit 425 is, for example, a portable battery, and performs control for supplying power to the device. Power states include, for example, a battery exhausted state in which there is no remaining power in the battery, a power-off state in which the power key 404 has not been pressed, an active state in which the device is operating normally, and a power saving state in which the device is operating but saving power.

The display unit 420 is the display unit 402 described with reference to FIG. 4A and performs, for example, display of the status and the operation status of the MFP 100 and various input operations, based on the control of the CPU 412. The operation unit 418 is the operation unit 403 described with reference to FIG. 4A and, upon receiving a user operation, executes control such as generating an electric signal corresponding to the operation and outputting it to the CPU 412.

The mobile terminal device 104 performs wireless communication using the WLAN unit 429 and performs data communication with another device, such as the MFP 100. The WLAN unit 429 converts data into packets and transmits the packets to another device. The WLAN unit 429 reconstructs original data from packets from another, external device and outputs it to the CPU 412. The WLAN unit 429 is a unit for realizing communications, respectively conforming to the WLAN standards. The WLAN unit 429 can operate in parallel in at least two communication modes, including the wireless infrastructure mode and the P2P (WLAN) mode. The frequency bands to be used in these communication modes may be limited according to the functions and performance of the hardware.

### Configuration of Access Point

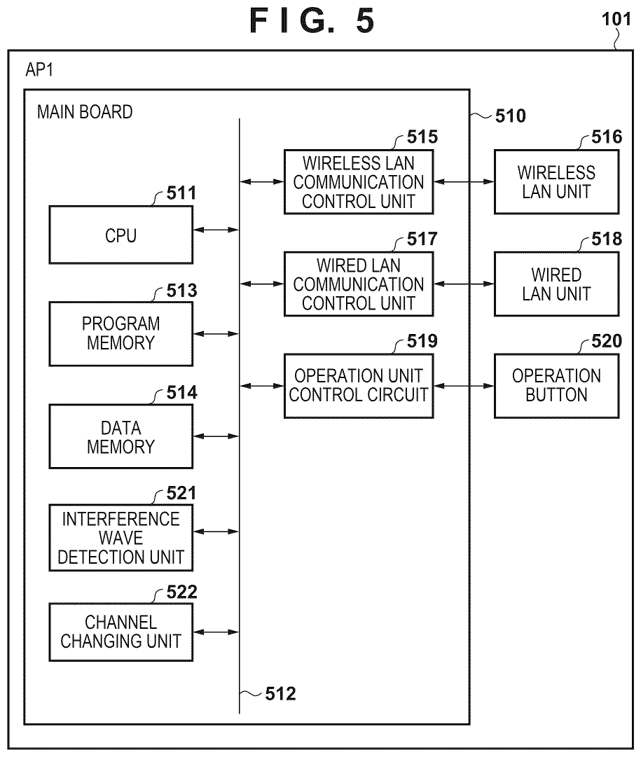

FIG. 5 is a block diagram illustrating a configuration of the AP 101 having a wireless LAN access point function. The AP 101 is configured to include a main board 510 which controls the AP 101, a wireless LAN unit 516, a wired LAN unit 518, and an operation button 520.

A CPU 511 in the form of a microprocessor arranged on the main board 510 operates according to a control program stored in a program memory 513 in the form of a ROM connected via an internal bus 512 and the contents of a data memory 514 in the form of a RAM. The CPU 511 performs wireless LAN communication with another communication terminal device by controlling the wireless LAN unit 516 through a wireless LAN communication control unit 515. The CPU 511 performs wired LAN communication with another communication terminal device by controlling the wired LAN unit 518 through a wired LAN communication control unit 517. The CPU 511 can receive an operation from the user through the operation button 520 by controlling an operation unit control circuit 519. The CPU 511 includes at least one processor.

Further, the AP 101 includes an interference wave detection unit 521 and a channel change unit 522. The interference wave detection unit 521 performs processing for detecting an interference wave when wireless communication is being performed in a frequency band in which Dynamic Frequency Selection (DFS) is performed. The channel change unit 522 performs processing for changing a channel to be used, for example, if an interference wave is detected or if an immediate change to a vacant channel is necessary, when wireless communication is being performed in a frequency band in which DFS is performed. The AP 102 has a configuration similar to that of the AP 101.

### P2P Communication Method

Next, a P2P (WLAN) communication system in which devices wirelessly communicate in a direct manner with each other without going through an external access point in WLAN communication will be outlined. P2P (WLAN) communication can be realized using a plurality of methods, and for example, a communication device can support a plurality of modes for P2P (WLAN) communication and selectively use any of the plurality of modes to perform P2P (WLAN) communication.

The following two modes are assumed as the P2P mode.
Soft AP Mode
Wi-Fi Direct (WFD) Mode

A communication device capable of executing P2P communication may be configured to support at least one of these modes. Meanwhile, a communication device capable of executing P2P communication need not support each of these modes and may be configured to support only one of them.

In a communication device (e.g., the mobile terminal device 104) having a communication function according to WFD, upon reception of a user operation through the operation unit thereof, an (in some cases, dedicated) application for realizing that communication function is called. The communication device may then display a user interface (UI) screen provided by that application to prompt a user operation and, based on the received user operation in response thereto, execute WFD communication.

### Soft AP Mode

In the soft AP mode, a communication device (e.g., the mobile terminal device 104) operates as a client, which requests various services. Another communication device (e.g., the MFP 100) operates as a software AP capable of executing a WLAN AP function with software-based settings. Regarding commands and parameters transmitted and received when a wireless connection is established between a client and a software AP, it is enough that those specified in the Wi-Fi® standard are used, and so, the description here will be omitted. The MFP 100, which operates in the soft AP mode, determines the frequency band and the frequency channel as the master station. Therefore, the MFP 100 can select which frequency band to use between 5 GHz and 2.4 GHz and which frequency channel to use in that frequency band.

### WFD Mode

The MFP 100 may always be activated as a WFD mode master station (Autonomous Group Owner). In this case, GO Negotiation processing for determining roles is unnecessary. Further, in this case, the MFP 100 determines the frequency band and the frequency channel as the master station. Therefore, the MFP 100 can select which frequency band to use between 5 GHz and 2.4 GHz and which frequency channel to use in that frequency band.

### Wireless Infrastructure Mode

In the wireless infrastructure mode, communication devices (e.g., the mobile terminal device 104 and the MFP 100) that communicate with each other are connected to an external AP (e.g., the AP 101) that controls a network, and communication between the communication devices is performed through that AP. In other words, communication between communication devices is performed via a network constructed by an external AP. The mobile terminal device 104 and the MFP 100 each discovering the AP 101, transmitting a connection request to the AP 101, and establishing a connection enables communication between these communication devices in the wireless infrastructure mode via the AP 101. A plurality of communication devices may be connected to different APs. In this case, data transfer between the APs enables communication between the communication devices. Regarding commands and parameters transmitted and received when communication devices communicate via an access point, it is enough that those specified in the Wi-Fi standard are used, and so, the description here will be omitted. Further, in this case, the AP 101 determines the frequency band and the frequency channel. Therefore, the AP 101 can select which frequency band to use among 5 GHz, 2.4 GHz, and 6 GHz and which frequency channel to use in that frequency band.

### Processing Performed in Response to Connection Destination Change Request from AP to STA

The mobile terminal device 104 and the MFP 100 support a function disclosed as Wi-Fi Agile Multiband®. Wi-Fi Agile Multiband is a function that allows selection of an optimum environment according to the changing status of a Wi-Fi network. Specifically, STAs, such as the mobile terminal device 104 and the MFP 100, and an AP, such as the AP 101, exchange information related to the network environment using IEEE 802.11 series communication standards. Such exchange of information allows the AP to direct (cause) an STA (to change the connection destination) to another AP, frequency band, or channel and, in some cases, to another cellular service when the network is congested.

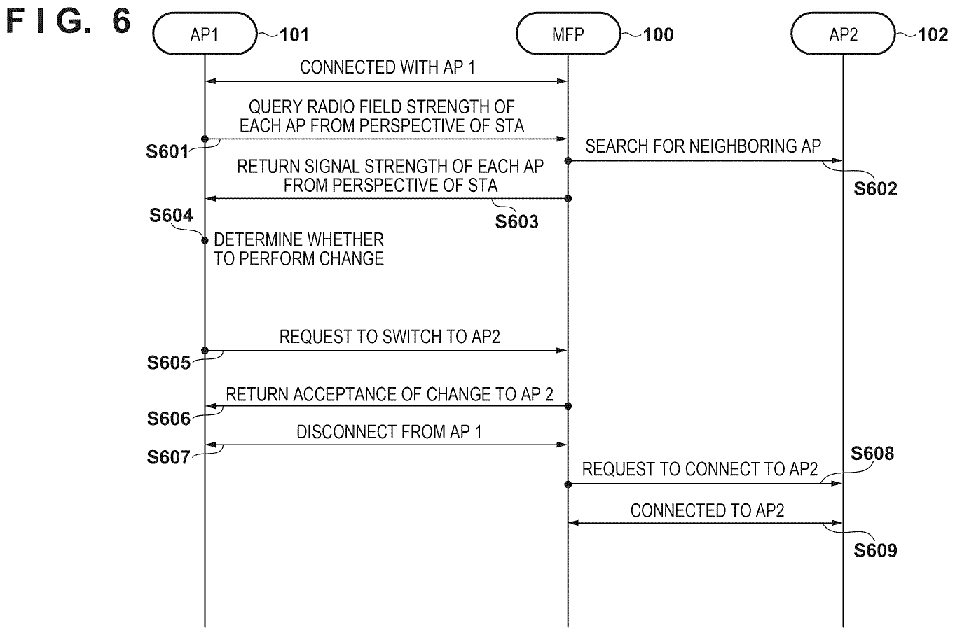

FIG. 6 is a sequence diagram for when the MFP 100 changes (switches) the connection destination AP from the AP 101 to the AP 102 according to a connection destination change request from the AP 101. The processes to be performed by the respective devices in this sequence are realized by the CPUs provided in the respective devices reading out, to the RAMs, various programs stored in memories such as the ROMs provided in the respective devices and executing the various programs.

In the initial state of the processing of FIG. 6, it is assumed that the MFP 100 has already established a connection with the AP 101 in the wireless infrastructure mode. In addition, it is assumed that, when the MFP 100 and the AP 101 connect in the wireless infrastructure mode, the AP 101 obtains information on whether the MFP 100 supports IEEE 802.11v and, when information that the MFP 100 supports IEEE 802.11v has been obtained, performs the following processing. The AP 101 determines whether the MFP 100 supports IEEE 802.11v based on an Association Request frame transmitted when the MFP 100 wirelessly connects to the AP 101.

In step S601, the AP 101 transmits, to the MFP 100, a query (measurement request) for signal strengths from APs in the vicinity of the MFP 100. This query can be transmitted including, for example, a beacon frame request or a beacon report request. That is, regarding this request, a mechanism specified in the IEEE 802.11k standard can be used.

In step S602, in response to the request received in step S601, the MFP 100 receives frames transmitted by neighboring APs and measures the signal strengths. By this, the signal strength of each of the plurality of the APs including the AP 101 and the AP 102 is measured.

In step S603, the MFP 100 transmits a list of signal strengths of APs in the vicinity of the MFP 100 measured in step S602 as a response to the request received in step S601. The signal strengths to be returned may be, in addition to or instead of the information measured in step S602, information stored in the RAM 214, the non-volatile memory 215, or the like of the MFP 100. This response is transmitted including, for example, a Beacon Report or a measurement report.

In step S604, the AP 101 determines whether the connection destination of the MFP 100 needs to be changed based on the status of congestion in the network that the AP 101 is aware of and the signal strength received in step S603 from the MFP 100. The reasons for the AP 101 to determine that the connection destination needs to be changed include there being many STAs (greater than or equal to a threshold) connected to the AP 101, large communication volume (greater than or equal to a threshold) between STAs connected to the AP 101 and the AP 101, the presence or absence of an interference wave which is determined based on an SN ratio or the like, stopping of the AP function, and the like. Further, whether the connection destination needs to be changed may be determined based on the degree of congestion (the number of connected STAs and the communication volume) of each AP, which is determined by using communication between APs. When it is determined that the connection destination of the MFP 100 needs to be changed and the SSID, the channel, and the frequency band of another AP to be designated as the change destination of the MFP 100 are determined, the processing proceeds to step S605. For example, the SSID of another AP designated as the change destination of the connection destination is the same SSID as the SSID of the AP before the change.

In step S605, the AP 101 transmits a connection destination access point (connection destination AP) change request (also referred to as connection destination switch request and connection destination change request) to the MFP 100. A connection destination AP change request includes information on the SSID, the channel, and the frequency band of another AP to be designated as the change destination (connection destination) for the MFP 100, which was determined in step S604. An AP to be designated as the change destination by the connection destination AP change request corresponds to an AP recommended for connection, which will be described later. A plurality of SSIDs may be designated. A connection destination AP change request is transmitted as, for example, a BTM Request. That is, a BSS Transition Management (BTM) Request frame specified by the IEEE 802.11v standard is transmitted. In the example of FIG. 6, it is assumed that the AP 102 is designated as the change destination by the connection destination AP change request.

In step S606, the MFP 100 transmits, to the AP 101, a response indicating acceptance of a change when complying with the connection destination AP change request received in step S605. When not complying with the connection destination AP change request, the MFP 100 may transmit a change rejection as a response. The response is transmitted as a BTM Response. In the example of FIG. 6, it is assumed that a response indicating acceptance of a change is transmitted.

In step S607, the AP 101 and the MFP 100 disconnect the connection in the wireless infrastructure mode. At this time, the MFP 100 does not yet delete but rather holds the information for connecting to the AP 101.

In step S608, the MFP 100 transmits a connection request to the AP 102 so as to connect to the AP 102 designated in the connection destination AP change request received in step S605. By this, in step S609, a connection in the wireless infrastructure mode between the MFP 100 and the AP 102 is established. When a connection in the wireless infrastructure mode between the MFP 100 and the AP 102 is established, the information for connecting to the AP 101 is deleted.

With such a mechanism, the MFP 100, which is an STA, can change the connection destination from the AP 101 to the AP 102 based on a connection destination AP change request from the originally connected AP 101. The AP 101 and the AP 102 may be APs installed in different locations. That is, the processing of FIG. 6 allows the MFP 100 to switch to another AP installed in a location that is different from an AP to which it had originally been connected. Further, the APs may be those provided by the same device and each supporting a different frequency band among a plurality of frequency bands (any two or three among the 2.4-GHz band, the 5-GHz band, and the 6-GHz band). That is, the processing of FIG. 6 allows the MFP 100 to switch to another frequency band provided by the same device as that of an AP to which it had originally been connected. For example, the connection destination can be changed to a 6-GHz band AP based on a connection destination AP change request.

In the present embodiment, an example in which a measurement request and a connection destination AP change request from an AP are transmitted and an STA responds thereto using a mechanism conforming to Wi-Fi Agile Multiband has been described, but the present invention is not limited thereto. The present embodiment can be applied to that in which an STA responds to or changes the connection destination AP (switches, deletes, or adds an AP to be the connection destination) in response to a measurement request and a connection destination AP change request transmitted from an AP using a mechanism different from the above example.

There are states in which there will be no problem even if the connection destination AP is changed based on the connection destination AP change request transmitted from the connected AP and states in which it is not desirable. In a state in which it is not desirable to change the connection destination AP based on a change request, one or a combination of a plurality of the following processes can be performed as processing for preventing a change of the connection destination AP to be performed in response to the change request. The following processes are each processing for preventing or making it difficult to perform a change of the connection destination AP.

### Prevention Processing 1

Even if the change request described in step S605 is received, a change of the connection destination AP based on the received change request is not performed and a response for the change request is not returned, or a response indicating rejection (that a change of the connection destination AP will not be performed) is transmitted to the connected AP for the change request. When a rejection response is transmitted, the connection destination AP change priorities of other STAs connected to the AP to which the MFP 100 is connected increase, and the connection destination AP change priority of the MFP 100, which returned a rejection response, decreases, and as a result, the connection with the connected AP may be maintained. In addition, it is considered that if a response is not returned (in the case of ignoring), the connected AP will maintain a connection with the MFP 100 so as to wait for a response until the response wait time elapses. Thus, if the state is such that the connection will immediately be disconnected in response to some response from the MFP 100 for the change request, the time in which the connection with the connected AP can be maintained can be increased when not responding than when returning some response. Therefore, for example, based on change reason information included in the change request, different processes may be taken depending on the reason, such as returning a rejection if the reason is weak and ignoring the request if the reason is strong. The reason for change can be determined based on, for example, information on which of a plurality of reasons included in a Request Mode included in a BTM Request applies. For example, if the Disassociation Imminent bit or the BSS Termination Included bit of the Request Mode is 1, it can be determined that the change request has a strong reason for change. Otherwise, it can be determined that the reason for change is weak.

### Prevention Processing 2

In response to the measurement request described in step S601, the MFP 100 returns (falsely responds with) information indicating that the signal reception conditions of non-connected APs, which are not a connected AP, are worse signal conditions (signal qualities) than the actually measured conditions. In this case, in response to reception of a measurement request, response may be performed upon actual measurement or response may be performed without actual measurement. Specifically, in the response (e.g., a beacon report) described in step S603, signal qualities measured as signals received from non-connected APs are returned with values obtained by reducing received signal strength and/or with values obtained by increasing noise (signal-to-noise ratios). Alternatively, the contents of a response may be such that at least one piece of information for each non-connected AP is not included. Further, it is possible to only perform one of a process for reducing received signal strengths to very low values or a process for responding with values obtained by significantly increasing noise based on previously measured information related to non-connected APs. Further, even if a measurement request is received, a good received signal strength or noise status only for the connected AP may be returned without performing actual measurement (AP search) and without including information on non-connected APs. A response to a measurement request that does not include information related to non-connected APs corresponds to content indicating that another, non-connected AP was not found even when an AP search was performed. That is, a response that does not include information related to non-connected APs is content indicating at least some of the signal qualities from the non-connected AP to be worse than those for when an AP search is actually performed. By doing so, it can be expected that transmission of a request to change the connection destination AP to another AP from the connected AP can be prevented. Therefore, a change of the connection destination in response to a connection destination AP change request is prevented.

### Prevention Processing 3

A connection with the connected AP is disconnected once, information that change requests are not supported is notified, and a connection with the same AP is re-established. Specifically, in preparation for disconnecting the wireless connection with the connected AP once and re-establishing a wireless connection, Association Request frame data including information indicating that IEEE 802.11v is not supported is created. Then, processing for connecting with the AP is performed using the created Association Request frame data. As a result, when an Association Request frame including information that IEEE 802.11v is not supported is created, the MFP 100 connects with the AP as an electronic device that does not support (is incompatible with) the Agile Multiband function. As a result, the connected AP recognizes that the MFP 100 does not support IEEE 802.11v and no longer transmits a connection destination AP change request to the MFP 100. The MFP 100 is thus no longer requested to change the connection destination AP, and so, it becomes easier to maintain the wireless connection between the MFP 100 and the connected AP. In addition, when the connected AP recognizes that the MFP 100 does not support IEEE 802.11v, transmission of a measurement request (request described in step S601) from the connected AP to the MFP 100 is prevented. Therefore, it is possible to prevent measurement (AP search) and response to a measurement request (processing of step S603) performed in response to a measurement request in the MFP 100. Therefore, the processing load and power consumption can be reduced, and resources can be allocated to other processing.

The states in which a change of the connection destination AP based on a change request is undesirable include, for example, reception of print data being in progress. During print data reception in the MFP 100, the state is such that a part of the print data of an image to be printed has been received from the mobile terminal device 104, which is a partner device, and the remaining part of the print data has not been received. In the MFP 100, there are cases where not all pieces of print data to be printed on one sheet are stored. Therefore, the MFP 100 performs printing by repeating: when a part of the print data is received, printing only the received part (e.g., receive and print one line), and when subsequent data is received, printing only that part. If the connection destination AP is changed based on a connection destination AP change request during this print data reception, a time lag associated with connection destination AP change processing may occur, which leads to print quality degradation, such as uneven printing. Further, after the connection destination AP is changed, communication with the mobile terminal device 104, which is the partner device, may no longer work, resulting in not being able to receive subsequent data and thus printing failure. Therefore, a configuration may be taken so as to, while print data is being received, perform at least one of the processes in the above prevention processing 1 and prevention processing 2 as processing for preventing connection destination AP change performed in response to a change request, or before print data reception is started, perform the processing in the above prevention processing 3.

When an STA such as a printer receives a connection destination AP change request (BTM Request) from an AP and changes the connection destination to another, recommended AP, it is unknown whether the STA can continue to communicate with other STAs such as a host terminal and various servers, with which it had been communicating via the AP before the change, even after the change of the connection destination AP. Therefore, for example, after the change of the connection destination AP, it may no longer be possible to perform printing on the printer from a smartphone, update firmware of the printer by communicating through an external server, and perform cloud printing which goes through an external server.

Therefore, in the present embodiment, when changing the connection destination AP, communication with another STA is confirmed, and a result of that communication confirmation is stored. Information of the connected AP (first AP) is also stored. Then, after changing the connection destination AP from the first AP to a second AP, when a previous communication confirmation result indicates that communication could be performed, communication with the other STA is confirmed again. Then, if a result of that communication confirmation indicates that communication cannot be performed, control is performed based on the stored information of the first AP so as to connect with the first AP. In the present embodiment, with such a configuration, it is possible to reduce occurrence of failures of communication with another STA due to a change of the connection destination AP.

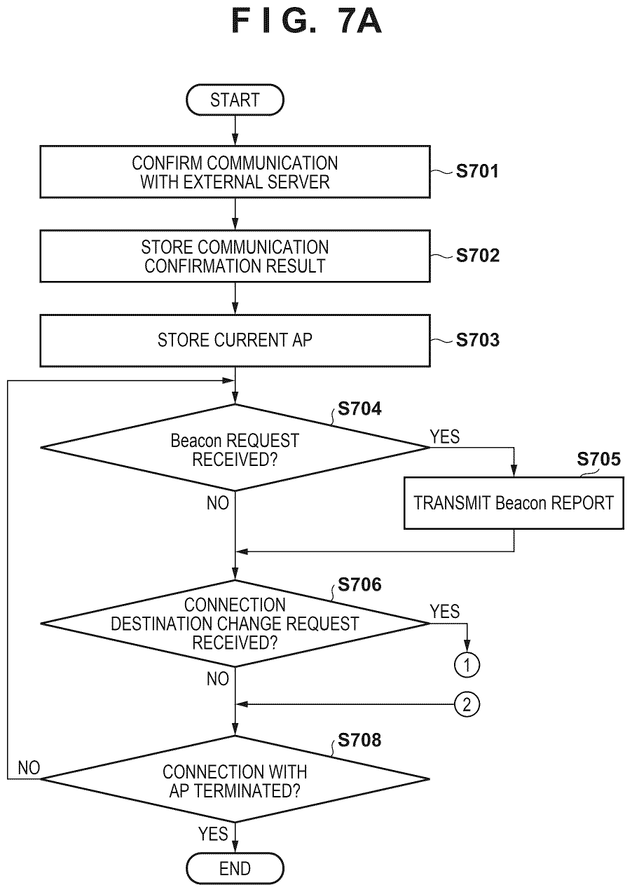

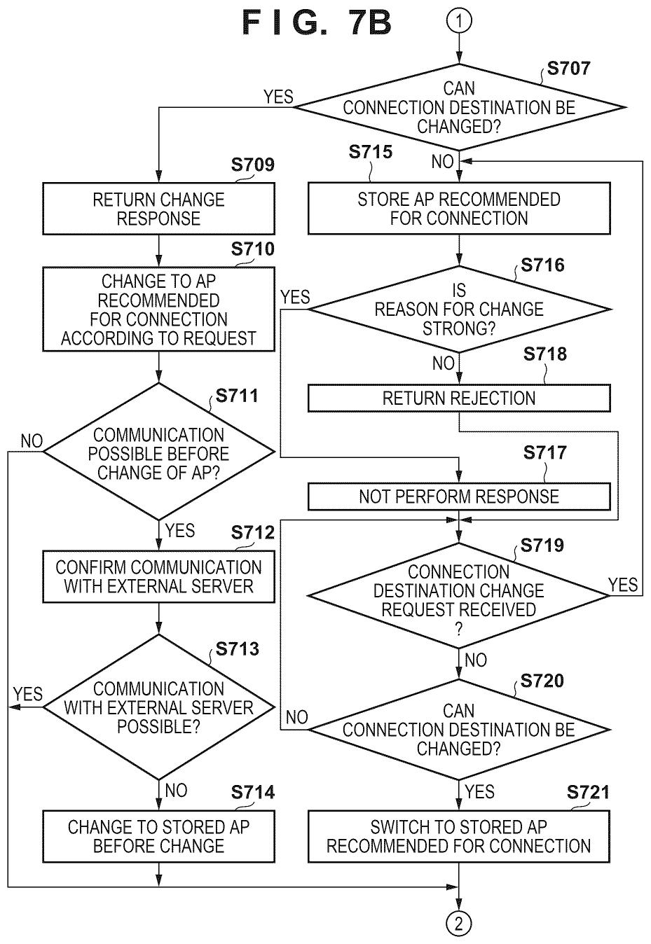

FIGS. 7A and 7B are flowcharts for explaining processing for changing the connection destination AP to be executed according to the state of the MFP 100 and the reason for change in the connection destination AP change request. The processing of FIGS. 7A and 7B is realized, for example, by the CPU 212 of the MFP 100 reading a program stored in the ROM 213 into the RAM 214 and executing the program.

When the processing of FIGS. 7A and 7B is started, the MFP 100 has already established a connection with the AP 101 in the wireless infrastructure mode. In addition, when the MFP 100 and the AP 101 connect in the wireless infrastructure mode, the AP 101 obtains information on whether the MFP 100 supports IEEE 802.11v. The processing of FIGS. 7A and 7B is executed if the AP 101 has obtained information that the MFP 100 supports IEEE 802.11v.

In step S701, the CPU 212 confirms whether communication with the external server 106 is possible through the AP 101. Description will be given using the external server 106 as an example of the above, other STA. However, it is not limited to the external server 106 and may be another server or the mobile terminal device 104. In step S701, for example, the CPU 212 may transmit, to the external server 106, an Internet Communication Message Protocol (ICMP) Echo Request of ICMP, which is a protocol used in network communication confirmation, and confirm whether an ICMP Echo Response has been received from the external server 106. For example, the CPU 212 may transmit data to the external server 106 and confirm whether a response has been received from the external server 106. Further, for example, the CPU 212 may transmit, to the external server 106, a Simple Network Management Protocol (SNMP) Get Request of SNMP, which is a protocol used for managing communication devices, and confirm whether an SNMP Get Response has been received from the external server 106.

In step S702, the CPU 212 stores, in the RAM 214, a result of confirmation as to whether communication is possible in step S701. In step S703, the CPU 212 performs storage control so as to store the information of the currently connected AP 101 in the RAM 214. Here, the information of the AP 101 includes information related to at least one among the SSID, the password, the channel, and the frequency band.

In step S704, the CPU 212 determines whether a query (measurement request) for signal strengths of APs in the vicinity of the MFP 100 has been received from the AP 101. This query can include, for example, a beacon frame request or a beacon report request, and in the present embodiment, either of the requests is included. Further, the query for signal strengths received in step S704 corresponds to that transmitted by the AP 101 in step S601 of FIG. 6. In step S704, if it is determined to have been received, the processing proceeds to step S705, and if it is determined to have not been received, the processing proceeds to step S706.

In step S705, the CPU 212 measures signal strengths of APs in the vicinity of the MFP 100 and transmits a list of signal strengths of APs to the AP 101 as a Beacon report. Step S705 corresponds to steps S602 and S603 of FIG. 6.

In step S706, the CPU 212 determines whether a connection destination AP change request transmitted by the AP 101 has been received. The connection destination AP change request here corresponds to that transmitted by the AP 101 in step S605 of FIG. 6. In step S706, if it is determined to have been received, the processing proceeds to step S707, and if it is determined to have not been received, the processing proceeds to step S708.

If the processing proceeds from step S706 to step S708, in step S708 the CPU 212 determines whether the connection with the connected AP 101 is continued. In step S708, if it is determined to be continued, the processing proceeds to step S704, and if it is determined to not be continued, that is, the connection with the AP 101 has been terminated, the processing of FIGS. 7A and 7B is terminated.

In step S707, the CPU 212 determines whether the connection destination AP can be changed. Specifically, for example, the CPU 212 performs the determination based on whether the MFP 100 is connected with the external server 106. If the connection with the AP 101 is immediately disconnected while being connected with the external server 106, communication ends up being forcibly interrupted without processing for terminating connection with the external server 106 being executed, and reconnection processing takes longer. Therefore, in the present embodiment, as an example, if the external server 106 is connected, it is determined that the connection destination AP cannot be changed (not possible). In step S707, if it is determined to be possible, the processing proceeds to step S709, and if it is determined to be not possible, the processing proceeds to step S715.

In step S709, the CPU 212 transmits, to the AP 101, a response indicating compliance with the received connection destination AP change request and proceeds to step S710. In step S710, the CPU 212 performs the processing of disconnecting the connection between the AP 101 and the MFP 100 and establishing a connection between an AP recommended for connection included in the connection destination AP change request, such as the AP 102, and the MFP 100. The AP recommended for connection is an AP indicated by information received from the AP 101 based on a mechanism conforming to Wi-Fi Agile Multiband. Further, the AP recommended for connection is an AP that is referenced when the connection destination of the MFP 100, which is an STA, is changed from the AP 101 to another AP based on a mechanism conforming to Wi-Fi Agile Multiband. Step S709 corresponds to step S606 of FIG. 6, and step S710 corresponds to the processing of steps S607 and S608.

In step S711, the CPU 212 references the result of confirmation as to whether communication with the external server 106 is possible stored in step S702 and determines whether it is indicated that communication is possible. If it is determined to not indicate that communication is possible, that is, the external server 106 could not be communicated with in step S701, the processing proceeds to step S708. Meanwhile, if it is determined to indicate that communication is possible, that is, the external server 106 could be communicated with in step S701, the processing proceeds to step S712. If the processing proceeds from step S711 to step S708, in step S708 the CPU 212 determines whether the connection with the connected AP 102 is continued. In step S708, if it is determined to be continued, the processing proceeds to step S704, and if it is determined to not be continued, that is, the connection with the AP 102 has been terminated, the processing of FIGS. 7A and 7B is terminated.

Another determination processing may be added before the determination of step S711 so as to proceed to step S711 only when a specific condition is satisfied. For example, if the external server 106 is a server for distributing firmware of the MFP 100, processing such as the following is added. First, when confirming whether communication with the external server 106 is possible in step S701, the CPU 212 detects whether there is distribution of new firmware and stores, in the RAM 214, whether there is distribution of new firmware. Then, before the determination of step S711, determination as to whether there is distribution of new firmware is performed, and only if it is determined that there is distribution of new firmware, the processing proceeds to step S711. Meanwhile, if it is determined that there is no distribution of new firmware, the processing proceeds to step S708. Further, for example, a configuration may be taken so as to determine whether setting for permitting communication with the external server 106 has been performed in advance by the user by operating the MFP 100. Only if it is determined that the setting has been performed, the processing proceeds to step S711, and if it is determined that the setting has not been performed, the processing proceeds to step S708.

In step S712, the CPU 212 confirms whether communication with the external server 106, with which communication had been possible in step S701, is possible through the connected AP (e.g., the AP 102, which is an AP indicated by the AP recommended for connection). The method of confirming whether communication is possible is similar to that in the description of step S701.

In step S713, the CPU 212 references the result of confirmation as to whether communication is possible in step S712 and determines whether it is indicated that communication is possible. If it is indicated that communication is possible, the processing proceeds to step S708. Meanwhile, if it is determined to not indicate that communication is possible, the processing proceeds to step S714. That is, when it is indicated that communication is possible, control is performed so as to not perform the processing of step S714, which will be described later. If the processing proceeds from step S713 to step S708, in step S708 the CPU 212 determines whether the connection with the connected AP 102 is continued. In step S708, if it is determined to be continued, the processing proceeds to step S704, and if it is determined to not be continued, that is, the connection with the AP 102 has been terminated, the processing of FIGS. 7A and 7B is terminated.

In step S714, the CPU 212 disconnects the connection between the MFP 100 and the AP 102. Then, the CPU 212 performs control such that the MFP 100 connects to the AP 101 based on the information of the SSID, the password, the channel, and the frequency band of the AP 101 before the change stored in the RAM 214 in step S703. That is, the CPU 212 performs processing for disconnecting the connection between the AP 102 and the MFP 100 and establishing the connection between the AP 101 and the MFP 100. In other words, the connection destination AP is changed (or switched) from the AP 102 to the AP 101. This makes it possible to reduce, for example, phenomena where the MFP 100 can no longer communicate with the external server 106, and network updates using the external server 106 by the MFP 100 and cloud printing which goes through the external server 106 can no longer be performed. Further, the above prevention processing 2 may be performed in step S705 in response to a measurement request from the AP 101 with which connection has been established in step S714. Further, the above prevention processing 3 may be performed when connecting with the AP 101 in step S714. This makes it possible to prevent transmission of a connection destination AP change request thereafter.

If the processing proceeds from step S714 to step S708, in step S708 the CPU 212 determines whether the connection with the connected AP 101 is continued. In step S708, if it is determined to be continued, the processing proceeds to step S704, and if it is determined to not be continued, that is, the connection with the AP 101 has been terminated, the processing of FIGS. 7A and 7B is terminated.

In step S715, the CPU 212 performs storage control so as to store, in the RAM 214 of the MFP 100, the information of the AP recommended for connection (e.g., the AP 102) included in the received connection destination AP change request and proceeds to step S716.

In step S716, the CPU 212 refers to the reason for change included in the received connection destination AP change request and determines whether there is a strong reason for change. If it is determined to be there, the processing proceeds to step S717, and if it is determined that to be not there, the processing proceeds to step S718. For example, if the Disassociation Imminent bit or the BSS Termination Included bit of the Request Mode of the BTM Request is 1, the CPU 212 determines that there is a strong reason for change.

In step S717, the CPU 212 performs control so as to not return a response to the connection destination AP change request and proceeds to step S719. In this case, since it is determined that there is a strong reason for change, it is thought that if a change rejection response is transmitted, the AP 101 will perform forced disconnection upon receiving the response. Therefore, when it is determined that there is a strong reason for change, control is performed so as to not return a response in anticipation of being able to maintain the connection until the response wait time elapses in the AP 101.

In step S718, the CPU 212 transmits, to the AP 101, a response indicating rejection of the change for the connection destination AP change request and proceeds to step S719. In this case, since it is determined that there is no strong reason for change, it is thought that even if a change rejection response is transmitted, the AP 101 will not perform forced disconnection upon receiving the response. Therefore, when it is determined that there is no strong reason for change, control is performed so as to transmit a change rejection response in anticipation of being able to maintain the connection without the AP 101 performing forced disconnection. The processing of step S718 corresponds to rejection response transmission at the timing of step S606 of FIG. 6. The processing of steps S717 and S718 corresponds to the above prevention processing 1.

In step S719, the CPU 212 determines whether a connection destination AP change request has been received again from the AP 101. If it is determined to have been received, the processing proceeds to step S715, and if it is determined to have not been received, the processing proceeds to step S720.

In step S720, the CPU 212 determines whether the state of the MFP 100 has entered a state in which the connection destination AP can be changed. Specifically, for example, the CPU 212 determines that the state in which the connection destination AP can be changed has been entered when the connection with the external server 106 has been terminated. If it is determined that the state in which the connection destination AP can be changed has been entered, the processing proceeds to step S721, and if it is determined that the state in which the connection destination AP can be changed has not been entered, that is, a state in which the connection destination AP cannot be changed is maintained, the processing proceeds to step S719. Specifically, for example, the CPU 212 determines that the state of the MFP 100 has entered the state in which the connection destination AP can be changed when the MFP 100 is no longer connected with the external server 106.

In step S721, the CPU 212 changes the connection destination AP to an AP indicated by the information of the AP recommended for connection stored in step S715. That is, the CPU 212 performs the processing of disconnecting the connection between the AP 101 and the MFP 100 and establishing a connection with an AP recommended for connection included in the connection destination AP change request, such as the AP 102, and the MFP 100. Then, the CPU 212 proceeds to step S708. The processing for changing the connection destination AP is the same as that in the description of steps S607, S608, and S609 of FIG. 6. Further, a configuration may be taken so as to perform processing similar to that of steps S711 to S714 after step S721.

If the processing proceeds from step S721 to step S708, in step S708 the CPU 212 determines whether the connection with the connected AP 102 is continued. In step S708, if it is determined to be continued, the processing proceeds to step S704, and if it is determined to not be continued, that is, the connection with the AP 102 has been terminated, the processing of FIGS. 7A and 7B is terminated.

As described above, according to the present embodiment, it is possible to reduce occurrence of failures of communication with another STA due to a change of the connection destination AP. Further, when a connection destination AP change request is received, by not returning a response if there is a possibility of forced disconnection and returning a rejection response if there is no possibility of forced disconnection, it is possible to maintain the connection with the AP 101 for as long as possible.

In addition, a configuration may be taken so as to, when a connection destination AP change request is received and it is determined in step S707 that the connection destination AP cannot be changed or it is determined in step S716 that there is a strong reason, start processing for resolving what is prohibiting the connection destination AP from being changed. Specifically, for example, a configuration may be taken so as to, if the connection destination AP cannot be changed due to a connection with the external server 106, start processing for terminating the connection with the external server 106. This makes it possible to, even in the case of forced disconnection from the AP 101, increase the possibility for the MFP 100 to enter the state, in which the connection destination AP can be changed, before the forced disconnection.

Further, in step S707, another determination criterion may be used. For example, determination may be performed based on whether print data is being received, other data different from the print data is being received, or other data is being transmitted. Specifically, for example, a configuration may be taken so as to perform determination based on whether the reading unit 219 has scanned a document and the scanned image (image data) is being transmitted to the mobile terminal device 104 through the AP 101. For example, when it is determined to be Yes in step S706, it is determined whether the reading unit 219 has scanned a document and transmission of image data is in progress, instead of or in addition to the determination of step S707. If it is determined to not be in progress, the processing proceeds to step S709, and if it is determined to be in progress, the processing of steps S715 to S721 is executed.

The above various kinds of control described to be performed by the MFP 100 may be performed by a single piece of hardware, or control of the entire device may be performed by a plurality of pieces of hardware (e.g., a plurality of processors and circuits) sharing processing.

Further, although detailed description has been given based on preferred embodiments, the present invention is not limited to these specific embodiments, and various forms in a scope that does not depart from the gist of the present invention are also included in the present invention. Further, each of the above embodiments merely illustrates one embodiment, and the embodiments can be combined as appropriate.

Further, in the above embodiment, description has been given using the MFP 100 as an example; however, the present invention is not limited to this example, and any wireless device that functions as an STA capable of performing processing in response to a connection destination change request from an AP is applicable. That is, a personal computer, a PDA, a tablet terminal, a mobile telephone terminal (e.g., a smartphone), a music player, a game console, an electronic book reader, a smartwatch, and various measuring devices (sensor devices such as a thermometer and a hygrometer) are applicable. Further, a digital camera (including a still camera, a video camera, a network camera, and a security camera), a printer, a scanner, and a drone are applicable. Further, a video output device, an audio output device (e.g., a smart speaker), a media streaming player, a wireless LAN station (adapter) that can be connected to a USB terminal or a LAN cable terminal, and the like are applicable. The video output device includes a device that realizes streaming reproduction in a display device and mirroring display (display in which the content displayed on an electronic device is also displayed on a display device) by, for example, obtaining (downloading) a moving image on the Internet identified by a URL instructed by the electronic device and outputting it to a display device connected through a video output terminal, such as HDMI®. Further, the video output device includes a media player (e.g., a TV, a hard disk recorder, a Blu-ray recorder, a DVD recorder), a head-mounted display, a projector, a TV, a display device (monitor), a signage device, and the like. Further, a device capable of Wi-Fi connection, which is a so-called smart home appliance, such as an air conditioner, a refrigerator, a washing machine, a vacuum cleaner, an oven, a microwave oven, a lighting fixture, a heating appliance, and a cooling appliance are applicable.

The present invention can be implemented by processing of supplying a program for implementing one or more functions of the above-described embodiments to a system or apparatus via a network or storage medium, and causing one or more processors in the computer of the system or apparatus to read out and execute the program. The present invention can also be implemented by a circuit (for example, an ASIC) for implementing one or more functions.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-060967, filed Apr. 4, 2024, which is hereby incorporated by reference herein in its entirety.

What is claimed is:

1. An electronic device comprising:
at least one memory and at least one processor configured to cause the electronic device to function as:
a reception unit configured to receive a request to change a connection destination access point;
a first change unit configured to change, based on the change request received by the reception unit, the connection destination access point from a first access point to a second access point;
a first confirmation unit configured to confirm, based on the connection destination access point being changed based on the change request, whether communication between the electronic device and a communication device via the second access point is possible;
a second change unit configured to change, based on the first confirmation unit confirming that communication between the electronic device and the communication device via the second access point is not possible, the connection destination access point from the second access point to the first access point.

2. The electronic device according to claim 1, wherein
the first confirmation unit confirms, based on a specific condition being satisfied, whether communication with the electronic device and the communication device via the second access point is possible.

3. The electronic device according to claim 2, wherein
the specific condition includes new firmware being detected.

4. The electronic device according to claim 2, wherein
the specific condition includes connection between the electronic device and the communication device being permitted.

5. The electronic device according to claim 1, the at least one processor being configured to further cause the electronic device to function as:
a second confirmation unit configured to confirm whether communication between the electronic device and an external communication device is possible via the first access point,
wherein the first confirmation unit confirms, based on the second confirmation unit confirming that communication between the electronic device and the communication device via the first access point is possible before the connection destination access point is changed based on the change request, whether communication between the electronic device and the communication device via the second access point is possible.

6. The electronic device according to claim 5, wherein
the first confirmation unit is controlled, based on the second confirmation unit not confirming that communication between the electronic device and the communication device via the first access point is not possible before the connection destination access point is changed based on the change request, so as to not confirm whether communication between the electronic device and the communication device via the second access point is possible.

7. The electronic device according to claim 1, wherein
in a case where the first confirmation unit confirms that communication between the electronic device and the communication device via the second access point is possible, the control unit controls so as to maintain a connection between the electronic device and the second access point.

8. The electronic device according to claim 1, the at least one processor being configured to further cause the electronic device to function as:
a prevention unit configured to execute, based on the first confirmation unit confirming that communication between the electronic device and the communication device via the second access point is not possible, prevention processing for preventing transmission of the change request from the first access point.

9. The electronic device according to claim 8, wherein
the prevention processing includes processing for falsely responding to a request to measure a signal strength of an access point in a vicinity of the electronic device from the first access point.

10. The electronic device according to claim 8, wherein
the prevention processing includes processing for transmitting information indicating that the electronic device does not support the change request when connecting with the first access point.

11. The electronic device according to claim 1,
the at least one processor being configured to further cause the electronic device to function as:
a storage control unit configured to, in a case where the electronic device and the communication device are connected when the change request is received by the reception unit, perform control so as to store information of the second access point,
wherein in a case where the electronic device stops being connected with the communication device, the first change unit changes the connection destination access point based on the change request received by the reception unit.

12. The electronic device according to claim 1, wherein
the communication device is a server that provides an update of software of the electronic device.

13. The electronic device according to claim 1, further comprising:
a printing unit configured to print an image on a print medium.

14. The electronic device according to claim 1, wherein
the electronic device is a device capable of operation supporting at least one among Orthogonal Frequency-Division Multiple Access (OFDMA) and Target Wake Time (TWT).

15. The electronic device according to claim 1, wherein
the electronic device is a device capable of operation conforming to IEEE 802.11ax.

16. The electronic device according to claim 1, wherein
in a case of performing control so as to change a connection destination based on the change request, the control unit performs control so as to perform a change to an access point whose frequency band is a 6-GHz band.

17. A method of controlling an electronic device to be executed in the electronic device, the method comprising:
receiving a request to change a connection destination access point;
changing, based on the received change request, the connection destination access point from a first access point to a second access point;
confirming, based on the connection destination access point being changed based on the change request, whether communication between the electronic device and a communication device via the second access point is possible;
changing, based on confirmation that communication between the electronic device and the communication device via the second access point is not possible, the connection destination access point from the second access point to the first access point.

18. A non-transitory computer-readable storage medium that stores one or more programs including instructions, which when executed by one or more processors of an electronic device, cause the electronic device to:
receiving a request to change a connection destination access point;
changing, based on the received change request, the connection destination access point from a first access point to a second access point;
confirming, based on the connection destination access point being changed based on the change request, whether communication between the electronic device and a communication device via the second access point is possible;
changing, based on confirmation that communication between the electronic device and the communication device via the second access point is not possible, the connection destination access point from the second access point to the first access point.
